(19) United States
(12) Patent Application Publication
(10) Pub. No.: US 2021/0006186 A1
(43) Pub. Date: Jan. 7, 2021

(54) IDENTIFICATION METHOD AND IDENTIFICATION DEVICE FOR IDENTIFYING TYPE OF BRUSHLESS DC MOTOR, AND BRUSHLESS DC MOTOR

(71) Applicant: Nidec Corporation, Kyoto (JP)

(72) Inventor: Hideyuki TAKEMOTO, Kyoto (JP)

(21) Appl. No.: 16/981,379

(22) PCT Filed: Mar. 5, 2019
(86) PCT No.: PCT/JP2019/008516

§ 371 Date: Sep. 16, 2020

(30) Foreign Application Priority Data
Mar. 23, 2018 (JP) 2018-056110

(51) Int. Cl. H02P 6/12

(52) U.S. Cl. CPC H02P 6/12

(57) ABSTRACT

An identification method used for an identification device that identifies information on a brushless DC motor output from the brushless DC motor, the identification method including supplying a power supply voltage from the identification device to the brushless DC motor via a power line, rotating the brushless DC motor in accordance with a Pulse Width Modulation signal output from a drive circuit of the brushless DC motor upon reception of supply of the power supply voltage, measuring a reaching time until a driving current flowing through the power line along with rotation of the brushless DC motor reaches a threshold value, and identifying information on the brushless DC motor based on the reaching time.

### CROSS REFERENCE TO RELATED APPLICATIONS

This application is a U.S. national stage application of PCT Application No. PCT/JP2019/008516, filed on Mar. 5, 2019, and priority under 35 U.S.C. § 119(a) and 35 U.S.C. § 365(b) is claimed from Japanese Application No. 2018-056110, filed on Mar. 23, 2018, the entire disclosures of which are hereby incorporated herein by reference.

### 1. FIELD OF THE INVENTION

The present disclosure relates to an identification method and an identification device for identifying a type of a brushless DC motor, and a brushless DC motor.

### 2. BACKGROUND

Many electronic devices include, for example, a fan motor as a cooling device for releasing heat generated inside to the outside. In an electronic device, a fan motor is electrically connected to a system controller and operates under the control of the system controller.

There is known an identification method for acquiring fan identification information by communication between a fan motor and a system controller. For example, the mode is switched from the normal mode to the command mode, and the fan motor and the system controller transmit and receive commands via a power line, a pulse width modulation (PWM) line, and a tachometer (TACH) line. The system controller acquires fan identification information by handshaking and determines compatibility with the fan motor. In this case, both the system controller and the fan require complicated control software such as software for switching between the normal mode and the command mode.

What is needed is a method of more easily identifying information on a brushless DC motor.

### SUMMARY

An identification method according to an example embodiment of the present disclosure is an identification method used in an identification device that identifies information on a brushless DC motor which is output from the brushless DC motor. The identification method includes supplying a power supply voltage from the identification device to the brushless DC motor via a power line, rotating the brushless DC motor in accordance with a Pulse Width Modulation (PWM) signal output from a drive circuit of the brushless DC motor upon reception of supply of the power supply voltage, measuring a reaching time until a driving current flowing through the power line along with rotation of the brushless DC motor reaches a threshold value, and identifying information on the brushless DC motor based on the reaching time.

An identification device according to an example embodiment of the present disclosure is an identification device that identifies information on a brushless DC motor output from a brushless DC motor including a drive circuit that generates a PWM signal and drives the motor. The identification device includes a power supply terminal to supply a power supply voltage to the brushless DC motor via a power line, and a controller to identify information on the brushless DC motor. The controller measures a reaching time until a driving current flowing through the power line by the brushless DC motor rotating according to the PWM signal output from the drive circuit of the brushless DC motor upon reception of supply of the power supply voltage from the power supply terminal via the power line reaches a threshold value, and identifies information on the brushless DC motor based on the reaching time.

A brushless DC motor according to an example embodiment of the present disclosure includes a circuit board, a power supply terminal that is on the circuit board to supply a power supply voltage from outside, a coil, and a drive circuit to energize the coil. The drive circuit waits for a standby time assigned to each type of a plurality of brushless DC motors after receiving supply of the power supply voltage, and then starts energizing the coil.

Another example brushless DC motor of an example embodiment of the present disclosure includes a circuit board, a power supply terminal that is on the circuit board to supply a power supply voltage from outside, a coil, and a drive circuit to energize the coil. The drive circuit changes a standby time from reception of supply of the power supply voltage to start of energization of the coil according to drive time of the brushless DC motor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a flowchart of an identification method for identifying a type of a brushless DC motor according to an example embodiment of the present disclosure.

FIG. 2 is a block diagram illustrating a typical block configuration example of a user system 100 and a brushless DC motor 200 according to a first example embodiment of the present disclosure.

FIG. 3 is a block configuration diagram illustrating a block configuration example inside the user system 100.

FIG. 4 is a block diagram illustrating another block configuration example of the user system 100 and the brushless DC motor 200 according to the first example embodiment.

FIG. 5 is a flowchart of an identification method for identifying a type of the brushless DC motor 200 according to the first example embodiment.

FIG. 6 is a graph exemplifying a state of a state change of the brushless DC motor 200.

FIG. 7 is a diagram exemplifying a table used to identify a type of the brushless DC motor 200 in the first example embodiment.

FIG. 8 is a flowchart of another identification method for identifying a type of the brushless DC motor 200 according to the first example embodiment.

FIG. 9 is a flowchart of an identification method for detecting drive time of the brushless DC motor 200 according to a variation of the first example embodiment.

FIG. 10 is a diagram exemplifying a table used to identify a type of the brushless DC motor 200 in a variation of the first example embodiment.

FIG. 11 is a block diagram illustrating a typical block configuration example of the user system 100, an identification device 100A, and the brushless DC motor 200 according to a second example embodiment of the present disclosure.

FIG. 12 is a block diagram illustrating another block configuration example of the user system 100, the identification device 100A, and the brushless DC motor 200 according to the second example embodiment.

### DETAILED DESCRIPTION

Hereinafter, example embodiments of identification methods and identification devices for identifying information on, particularly a type of, brushless DC motors of example embodiments of the present disclosure will be described in detail with reference to the accompanying drawings. However, in order to avoid the following description from being unnecessarily redundant and to make it easier for those skilled in the art to understand, a detailed description more than necessary may be omitted. For example, a detailed description of a well-known item or a redundant description of substantially the same configuration may be omitted. Further, example embodiments of the present invention are not limited to devices or methods exemplified below. For example, an example embodiment can be combined with another example embodiment.

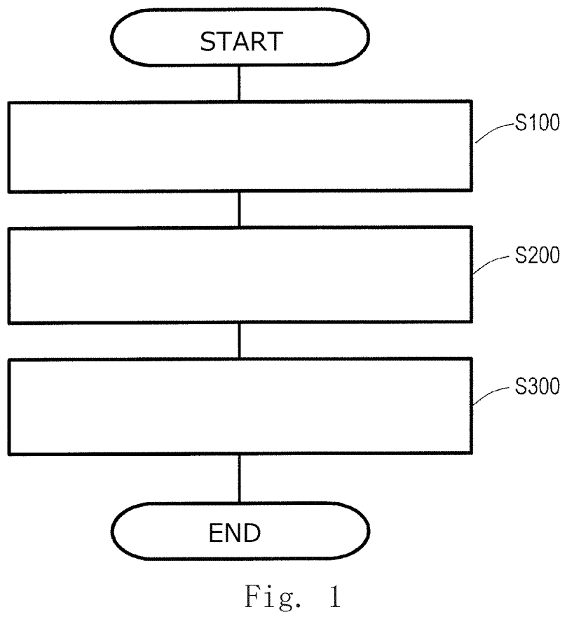

Before example embodiments of the present disclosure is explained, an overview of the identification methods according to example embodiments of the present disclosure will be described with reference to FIG. 1. FIG. 1 is a flowchart of an identification method for identifying information on a brushless DC motor according to an example embodiment of the present disclosure.

An identification method according to an example embodiment of the present disclosure is an identification method used for an identification device, for identifying information on a brushless DC motor output from the brushless DC motor. The brushless DC motor is typically a two-wire motor having a power supply terminal and a GND terminal, and includes a drive circuit. The drive circuit adjusts a timing of outputting a PWM signal based on information on a brushless DC motor.

The identification method according to the present example embodiment of the present disclosure includes a step of supplying a power supply voltage, that is, power, from an identification device to a brushless DC motor via a power line (Step S100), a step of rotating a brushless DC motor according to a PWM signal output from a drive circuit of the brushless DC motor upon reception of supply of a power supply voltage, and measuring reaching time until driving current flowing through a power line along with the rotation reaches a threshold value (Step S200), and a step of identifying information on a brushless DC motor based on the measured reaching time (Step S300). Information on the brushless DC motor is information including, for example, a type of a brushless DC motor, a product lot number, drive time of a brushless DC motor, elapsed time from manufacture, elapsed time from start of use, actual time of actual use, the number of years of use, the number of remaining days until a warranty period, or the number of times of activation, and the like.

### First Example Embodiment

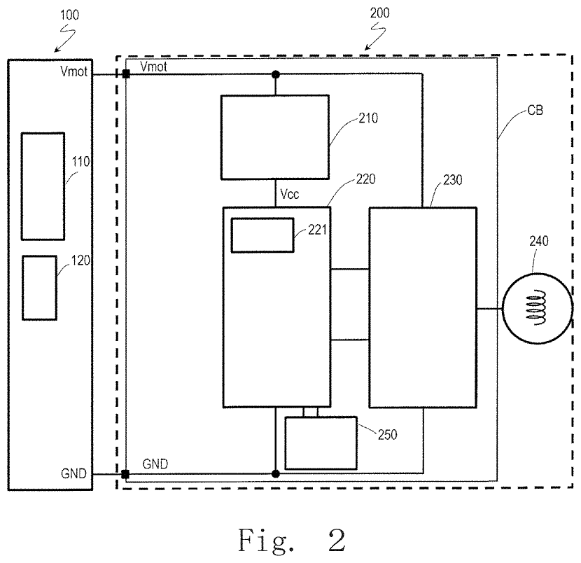

FIG. 2 schematically shows a typical block configuration example of a user system 100 and a brushless DC motor 200 according to the present example embodiment. In this specification, the structure and operation of the brushless DC motor 200 will be described using a fan motor as an example. The brushless DC motor according to the present disclosure includes an inner rotor type or outer rotor type motor. The brushless DC motor 200 is not limited to a fan motor, and is a brushless DC motor used for various applications. The brushless DC motor 200 is, for example, a motor used for home appliances such as an air conditioner or a washing machine, and a vehicle-mounted motor.

The user system 100 is electrically connected to the brushless DC motor 200. The user system 100 can supply power to the brushless DC motor 200. The user system 100 can be mounted on a brushless DC motor production management system in a factory that produces a wide variety of products. The user system 100 is a system in an electronic device on which the brushless DC motor 200 can be mounted or a vehicle-mounted system. For example, the brushless DC motor 200 is preferably mounted on an electronic device such as a server, the main body of a desktop personal computer, or a game machine. For example, in a case where the brushless DC motors 200 with different specifications are produced in the same location, the user system 100 is part of a series of inspection systems. Alternatively, in a case where the brushless DC motor 200 is mounted as a fan motor on the main body of a server or a desktop personal computer, the user system 100 is the entire system constituted by various electronic components mounted on a motherboard or part of the system.

The user system 100 includes, for example, a controller 110 and a memory 120. The user system 100 according to this example embodiment has a function of identifying the type of the brushless DC motor 200, as described later. In other words, the user system 100 can be used as an identification device for identifying the type of the brushless DC motor 200. Therefore, in this specification, the user system 100 is sometimes referred to as the identification device 100.

The controller 110 mainly controls the entire user system 100 and can control power supply to the brushless DC motor 200. The controller 110 can further identify the type of the brushless DC motor 200. The controller 110 is, for example, a semiconductor integrated circuit such as a micro control unit (MCU) or a field programmable gate array (FPGA).

The memory 120 is, for example, a writable memory (for example, PROM), a rewritable memory (for example, flash memory), or a read-only memory. The memory 120 stores, for example, a control program having a command group for causing the controller 110 to identify the type of the brushless DC motor 200. For example, the control program is temporarily expanded in a RAM (not shown) at the time of booting. The memory 120 need not be externally attached to the controller 110, and may be mounted on the controller 110. The controller 110 including the memory 120 is, for example, the above-described MCU.

The user system 100 includes a Vmot terminal and a GND terminal as connection terminals to be connected to the brushless DC motor 200. The Vmot terminal is a terminal for a motor power supply. For example, a motor power supply voltage Vmot within a range of 7.0 to 13.8 V is supplied to the brushless DC motor 200 from the Vmot terminal.

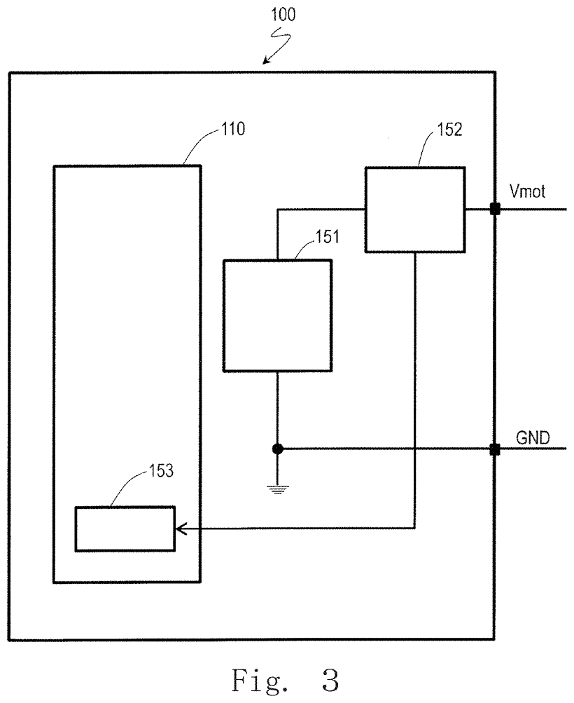

FIG. 3 schematically shows a more detailed block configuration example inside the user system 100.

The user system 100 further includes, for example, a DC power supply 151, a current detector 152, and a discriminator 153. In a case of referring to a block configuration inside the user system 100 or the identification device 100, the constituent elements of the controller 110, the DC power supply 151, the current detector 152, and the discriminator 153 may be collectively referred to simply as “controller 110”.

The DC power supply 151 is a constant voltage source, and generates a motor power supply voltage Vmot (for example, 7.0 to 13.8 V) to be supplied to the brushless DC motor 200 in motor drive during normal operation and identification. The motor drive during normal operation means driving the motor in a state where an inverter 230 of the brushless DC motor 200 is operated by supplying power to the inverter 230. The DC power supply 151 may include a current limiting function for limiting the current.

The current detector 152 detects a driving current flowing through the power line in identification of a type of the brushless DC motor 200. The current detector 152 detects (or samples) a driving current at time intervals of 50 μs, for example. When the brushless DC motor 200 starts rotating, a driving current starts flowing in the power line, and eventually reaches a threshold value. The threshold value is a current equal to or less than a rated current, and is set to half the rated current, for example.

The discriminator 153 measures reaching time until a driving current reaches the threshold value by monitoring a current detection value output from the current detector 152. In the present example embodiment, the reaching time differs depending on types of a plurality of brushless DC motors. Furthermore, the discriminator 153 discriminates a type of the brushless DC motor 200 based on the measured reaching time. The discriminator 153 is typically mounted on the controller 110.

FIG. 2 is referred to again.

The brushless DC motor 200 is, for example, a DC fan having an impeller. The brushless DC motor 200 is, for example, an axial fan, a centrifugal fan, a crossflow fan, or a sirocco fan. The brushless DC motor 200 typically includes a regulator 210, a motor drive IC 220, an inverter 230, a circuit board CB on which those electronic components are mounted, a coil 240, and a Hall element 250. For example, the regulator 210, the motor drive IC 220, the inverter 230, and the Hall element 250 constitute a motor drive circuit for energizing the coil 240 to drive the motor.

The regulator 210 lowers a motor power supply voltage Vmot of, for example, 13.8 V to generate a power supply voltage Vcc (for example, 5.0 V) for the motor drive IC 220. In the brushless DC motor 200, the power supply voltage Vcc supplied to the motor drive IC 220 is preferably generated based on the motor power supply voltage Vmot. As a result, it is not necessary to provide a terminal for the power supply voltage Vcc in the brushless DC motor 200, and the number of terminals and lead wires can be reduced. However, the power supply voltage Vcc may be supplied from the user system 100 to the brushless DC motor 200 separately from the motor power supply voltage Vmot.

The motor drive IC 220 includes, for example, an MCU 221 and is connected to the inverter 230. The MCU 221 generates a PWM signal for controlling the rotation of the motor. The motor drive IC 220 generates a control signal for controlling inverter 230 in accordance with a PWM signal and outputs the control signal to inverter 230.

In the present example embodiment, time from when the motor drive IC 220 is supplied with the power supply voltage Vcc to when output of a PWM signal is started (hereinafter referred to as “standby time”) is set as unique information of a brushless DC motor, and assigned to each type of a plurality of brushless DC motors. The MCU 221 incorporates a general timer function. For example, the MCU 221 uses this function to stop the generation of a PWM signal from the start of feeding of the power supply voltage Vcc until the standby time elapses. In this manner, drive of the inverter 230 can be stopped during the standby time.

For example, the standby time can be assigned as unique information of a brushless DC motor for each supplier that manufactures brushless DC motors. For example, the standby time of 100 ms can be assigned to Supplier A, the standby time of 200 ms can be assigned to Supplier B, and the standby time of 300 ms can be assigned to Supplier C. Furthermore, the standby time different from these can be assigned to a plurality of suppliers.

For example, the standby time can be assigned as unique information for each product lot. For example, the standby time of 100 ms can be assigned to Product Lot Number A, the standby time of 200 ms can be assigned to Product Lot Number B, and the standby time of 300 ms can be assigned to Product Lot Number C. Furthermore, the standby time different from these can be assigned to a plurality of product lot numbers. Thus, the types of the plurality of brushless DC motors are, for example, as many as the number of suppliers or as many as the number of product lots to be managed.

The motor drive IC 220 monitors the rotational speed of the motor based on, for example, an output from the Hall element 250, and generates a PWM signal in accordance with the rotational speed of the motor. The output method is, for example, a method of outputting two pulses per rotation. However, a technique that does not use a Hall element is known. In employing such a technique, the Hall element 250 is not essential.

The inverter 230 is electrically connected to the motor drive IC 220 and the coil 240 of the motor. The inverter 230 converts the power of the motor power supply to the power supplied to the fan motor under the control of the motor drive IC 220, and energizes the coil 240 of the motor.

The coil 240 is the winding of the motor.

The brushless DC motor 200 includes, for example, the circuit board CB on which the Vmot terminal and the GND terminal are arranged in correspondence with terminals on the user system 100 side.

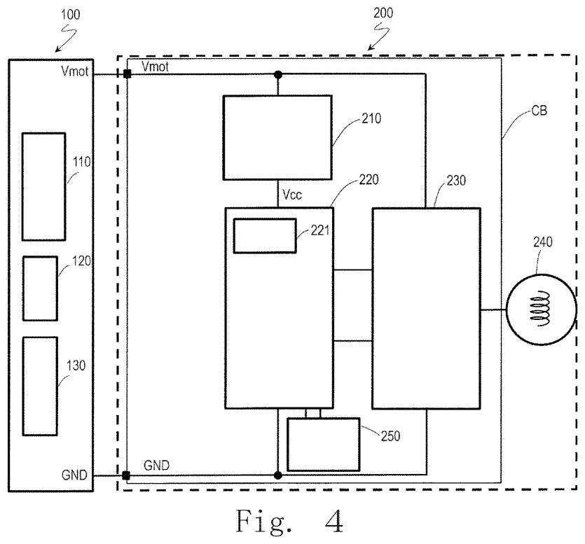

FIG. 4 schematically shows another block configuration example of the user system 100 and the brushless DC motor 200.

The user system 100 may further include a light-emitting element 130. The light-emitting element 130 has, for example, a plurality of light-emitting diodes (LEDs). The light-emitting element 130 is a notification device that notifies an identification result of a type of the brushless DC motor 200. For example, a plurality of LEDs can be provided by the number of types of a plurality of brushless DC motors. For example, if there are two types of brushless DC motors of suppliers A and B, two LEDs with different emission colors can be provided. For example, a red LED for supplier A and a blue LED for supplier B can be provided.

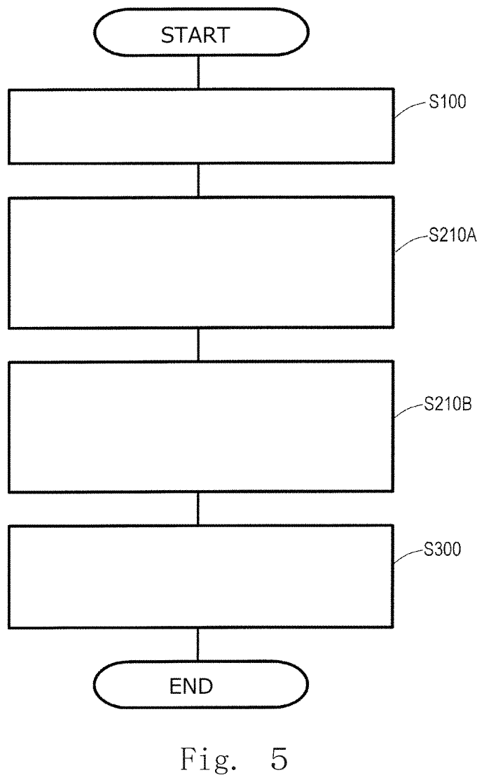

FIG. 5 shows a flowchart of an identification method for identifying a type of the brushless DC motor 200 according to the present example embodiment.

The identification method according to this example embodiment is a method used for, for example, the identification device 100. In a process of manufacturing a variety of products equipped with motors, it is generally necessary to identify a type of a brushless DC motor in order to prevent mixing of different types of motors. For example, the identification method according to the present disclosure is suitably used for a method for inspecting the compatibility of a brushless DC motor with a user system when manufacturing a product in a factory. For example, a step of checking the compatibility of a brushless DC motor can be incorporated as part of a process of manufacturing a product.

First, power supply voltage is supplied from the identification device 100 (user system 100) to the brushless DC motor 200 with the terminals of the identification device 100 and the brushless DC motor 200 electrically connected. A voltage equal to the motor power supply voltage Vmot to be supplied to the brushless DC motor 200 in motor drive during normal operation is supplied as power supply voltage for identification.

The motor drive IC 220 outputs a PWM signal after waiting for the standby time specific to a type of a brushless DC motor. It is preferable that the motor drive IC 220 output a PWM signal after the lapse of a predetermined time from receiving of supply of the power supply voltage Vcc and further waiting for the standby time. The predetermined time is set to be the time until the power supply voltage Vcc stabilizes or more. In this manner, the motor drive IC 220 can be operated more normally.

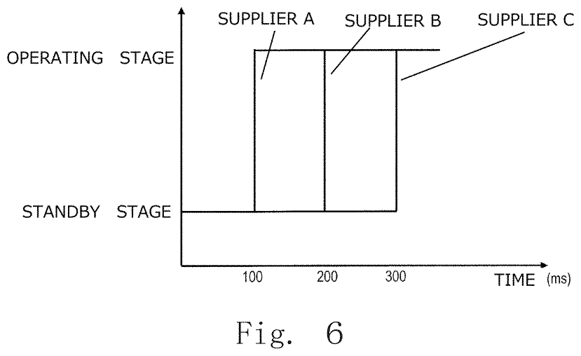

FIG. 6 is a graph exemplifying a state of a state change of the brushless DC motor 200 after the motor power supply voltage Vmot is fed. A horizontal axis of the graph represents time (has), and a vertical axis represents a state of the motor (driving current). For example, the standby time of Supplier A is 100 ms, the standby time of Supplier B is 200 ms, and the standby time of Supplier C is 300 ms. A standby state in the diagram shows a state in which the motor drive IC 220 waits for the standby time after the motor power supply voltage Vmot is fed, and an operating state shows a state in which the brushless DC motor 200 operates in response to a PWM signal output from the motor drive IC 220. In this operating state, a driving current flows through the power line.

Since the standby time is assigned to each type of a plurality of brushless DC motors, transition time for the brushless DC motor 200 to make a transition from the standby state to the operating state differs depending on suppliers. The transition time corresponds to the standby time described above, and the transition time of Supplier A is 100 ms, the transition time of Supplier B is 200 ms, and the transition time of Supplier C is 300 ms.

The discriminator 153 is used to measure the transition time of the brushless DC motor 200. Specifically, this measurement is performed as the discriminator 153 measures the reaching time until the driving current reaches the threshold value. Here, the reaching time is equal to the transition time. In the present example embodiment, the threshold value is set to the rated current. That is, in the operating state, the rated current flows as the driving current.

The discriminator 153 is used to discriminate a type of the brushless DC motor 200 based on the measured reaching time. Specifically, the discriminator 153 discriminates a type of a motor based on the measured reaching time with reference to a table.

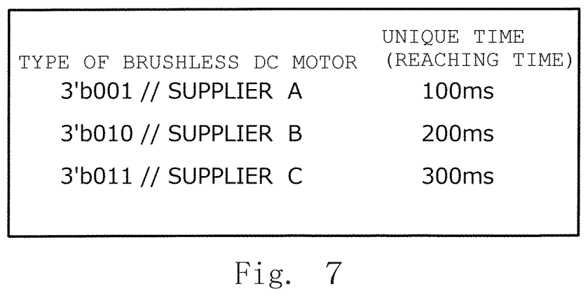

FIG. 7 exemplarily shows the table used to identify a type of the brushless DC motor 200. The table is a look-up table (LUT) that associates a plurality of types of brushless DC motors with the unique information of the plurality of brushless DC motors. The unique information of the brushless DC motor represents a different reaching time, that is, a transition time for each of a plurality of brushless DC motors. The table is stored in, for example, the memory 120. As described above, a plurality of types of brushless DC motors exist, for example, for each supplier, and for example, there are three types of suppliers A, B, and C. For example, the type of motor can be represented by, for example, a 3-bit digital signal.

For example, the discriminator 153 may include an AD converter (not shown). The discriminator 153 converts the measured reaching time (analog value) into a digital signal. The unique information of the brushless DC motor can also be represented by a digital value having the same bit width as the resolution of AD conversion. Note that at least one of measurement of the reaching time and processing of AD conversion can be implemented in the current detector 152 in a preceding stage.

The transition from the standby state to the operating state also indicates that the drive of a motor during normal operation has started. The brushless DC motor 200 rotates according to a PWM signal from the motor drive IC 220 after transition to the operating state. As described above, the identification of a type of the brushless DC motor 200 can be incorporated in a sequence of motor drive during normal operation.

According to the identification method of the present example embodiment, it is possible to identify a type of the brushless DC motor 200 based on the reaching time until the driving current reaches the threshold value. The motor drive IC 220 can seamlessly control motor drive without paying attention to processing on the identification device 100 side. Conventionally, communication by handshaking between the identification device 100 and the brushless DC motor 200 is unnecessary. In addition, an existing power supply terminal can be used, and it is not necessary to newly provide a dedicated terminal for identification. The product cost can be reduced by reducing the number of parts. Since input and output terminals such as a PWM terminal and a TACH terminal are not particularly required for identification, a particular advantage is obtained for identification of a type of a two-wire motor.

The identification method according to the present disclosure is preferably used not only at the time of product manufacture but also, for example, when replacing a failed brushless DC motor with a new brushless DC motor. You can check whether the replaced brushless DC motor is compatible with the system. Also, for example, each product equipped with a brushless DC motor is connected to the Internet. The so-called internet of things (IoT) is implemented. For example, the supplier of an individual product equipped with a brushless DC motor can identify a product equipped with a specific brushless DC motor by analyzing big data including the unique information of the brushless DC motor. This can stabilize the quality, for example, by preventing the occurrence of defects.

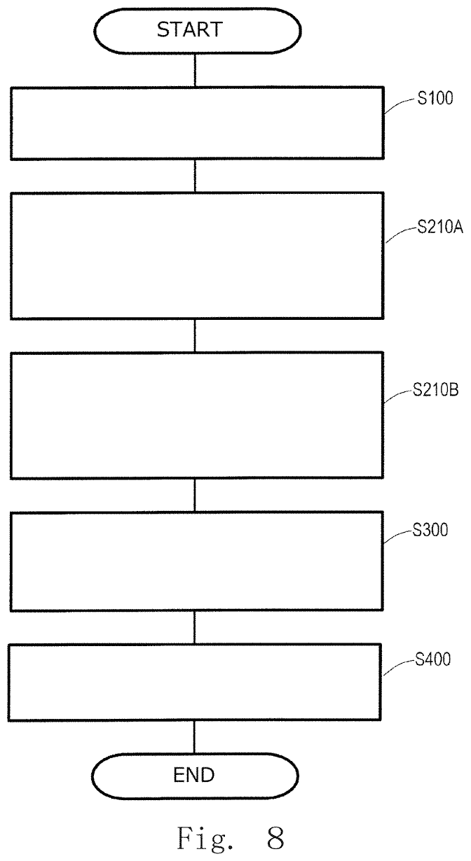

FIG. 8 shows another specific example of a flowchart for the identification method for identifying a type of the brushless DC motor 200.

As shown in FIG. 8, the identification method according to the present example embodiment can further include step S400 of notifying a result of identifying a type of the brushless DC motor 200.

As an example of a notification method, it is possible to report a result of identifying a type of the brushless DC motor 200 using the light-emitting element 130 (for example, a plurality of LEDs) shown in FIG. 4. The controller 110 of the identification device 100 causes the LED assigned to the brushless DC motor 200 to be identified, among the plurality of LEDs assigned to the respective types of brushless DC motors, to emit light based on the result of identifying the type of the brushless DC motor 200. Note that the light-emitting element is not limited to an LED, and may be an element that notifies by light.

For example, a red LED can be assigned to supplier A, a blue LED can be assigned to supplier B, and a green LED can be assigned to supplier C. Upon identifying the brushless DC motor of supplier C, the controller 110 of the identification device 100 can cause the green LED to emit light. Thus, for example, a factory worker can visually recognize whether or not the brushless DC motor to be identified is a motor of supplier C.

As another example, it is possible to notify the result of identifying the type of the brushless DC motor 200 by using a display device (for example, a liquid crystal display) or a loudspeaker. For example, the identification result can be displayed on a liquid crystal display as character information. For example, it is possible to change the pitch of the sound for each type of a plurality of brushless DC motors and make the loudspeaker generate sound.

As another example, the controller 110 of the identification device 100 may temporarily write the identification result in the memory 120 or transmit it to another apparatus or device that needs the identification result. These forms are also modes of notifying an identification result.

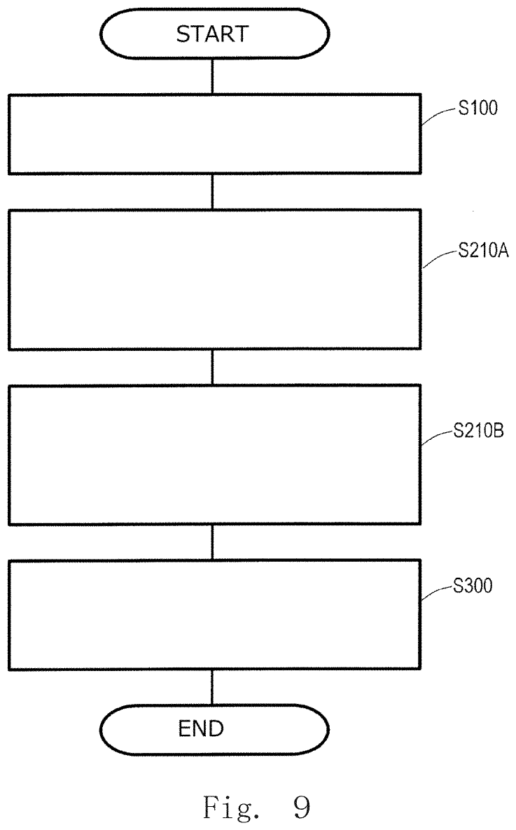

FIG. 9 shows a flowchart of the identification method for identifying a type of the brushless DC motor 200 according to a variation of the present example embodiment. As described above, information on a brushless DC motor is not limited to a type of the brushless DC motor, and may be, for example, drive time of a brushless DC motor. Hereinafter, one mode in which drive time of a brushless DC motor is detected based on the reaching time measured by the discriminator 153 will be described. The drive time specifically refers to cumulative time of operation of the motor drive IC 220. Further, in the present description, for example, elapsed time from manufacture, elapsed time from start of use, actual time of actual use, the number of years of use, the number of remaining days until a warranty period, the number of times of activation, or the like is included in the concept of the drive time in the present disclosure.

The motor drive IC 220 according to the present variation changes the standby time from start of feeding of the power supply voltage Vcc to output of a PWM signal according to the drive time. For example, the motor drive IC 220 sets the standby time appropriately according to the drive time as initial operation when the power supply voltage Vcc is fed.

For example, consider a brushless DC motor with the life of 3000 hours. In a case where the drive time is 2000 hours or less, the motor drive IC 220 sets 100 ms as the standby time. In a case where the drive time is more than 2000 hours and 2500 hours or less, the motor drive IC 220 sets 200 ms as the standby time. In a case where the drive time is more than 2500 hours and 2900 or less, the motor drive IC 220 sets 300 ms as the standby time. In a case where the drive time is more than 2900 hours and 3000 or less, the motor drive IC 220 sets 400 ms as the standby time. In this manner, as the end of the life approaches, an interval of a section of the drive time is set shorter, so that a state of the brushless DC motor approaching the end of the life can be grasped in detail.

The motor drive IC 220 waits for the standby time set according to the drive time, and outputs a PWM signal (Step S210A). The current detector 152 detects the driving current and outputs the driving current to the discriminator 153. The discriminator 153 measures the reaching time until the driving current reaches the threshold value by monitoring a current detection value (Step S210B).

The discriminator 153 is used to detect the drive time of the brushless DC motor 200 based on the measured reaching time. Specifically, the discriminator 153 detects the drive time of the brushless DC motor 200 based on the measured reaching time with reference to a table.

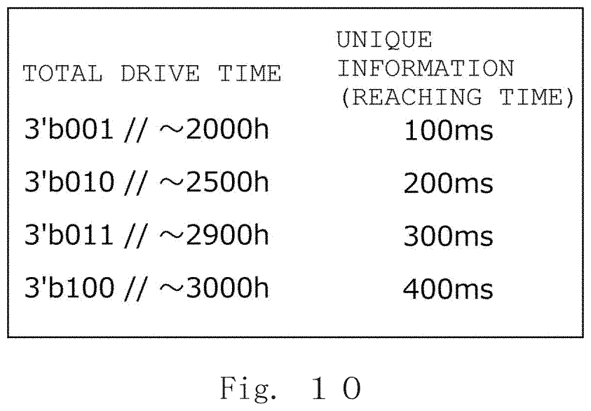

FIG. 10 exemplarily shows the table used to detect the drive time of the brushless DC motor 200. The table is a look-up table (LUT) that associates the drive time of the brushless DC motor 200 with the unique information of the brushless DC motor. The unique information of the brushless DC motor represents the reaching time that differs depending on the drive time.

According to the present variation, for example, by associating the drive time of the brushless DC motor 200 with the standby time, the drive time of the brushless DC motor 200 can be easily grasped based on the measured reaching time.

### Second Example Embodiment

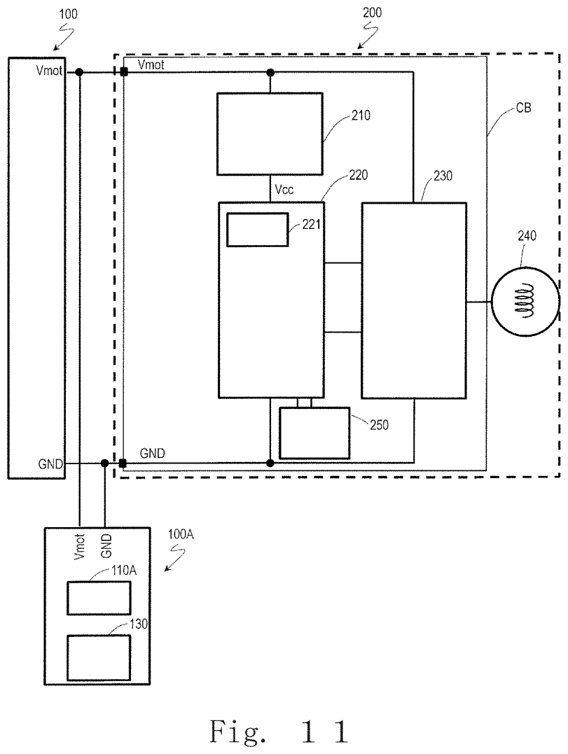

FIG. 11 schematically shows a typical block configuration example of a user system 100, a discriminator 100A, and a brushless DC motor 200.

Unlike the first example embodiment, the identification device 100A according to this example embodiment is a device separate from the user system 100. The identification device 100A includes, for example, an MCU 110A equipped with the DC power supply 151, the current detector 152, and the discriminator 153, and the light-emitting element 130. It should be noted that the DC power supply 151, the current detector 152, and the discriminator 153 are not shown in FIG. 11 to avoid complexity of the drawing. The identification device 100A includes a Vmot terminal and a GND terminal as terminals necessary for identifying the type of the brushless DC motor 200.

The user system 100, the identification device 100A, and the brushless DC motor 200 are electrically connected to each other between the Vmot terminal and the GND terminal. A power supply voltage can be supplied from the identification device 100A to the brushless DC motor 200 via the Vmot terminal.

The identification device 100A can identify a type of the brushless DC motor 200 or detect the drive time, for example, according to a processing process shown in FIG. 8 or 9 after the power is turned on. The MCU 110A may transmit the identification result to the controller 110 of the user system 100.

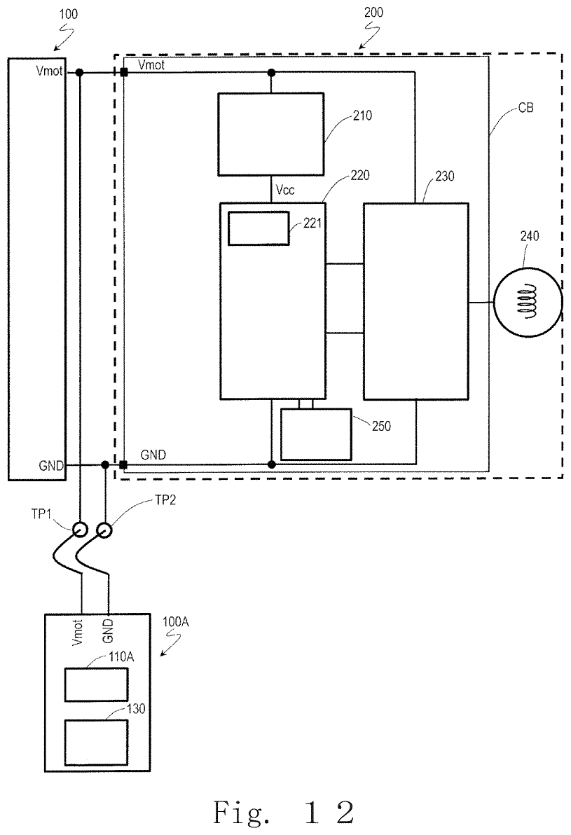

FIG. 12 schematically shows another example of the block configuration of the user system 100, the identification device 100A, and the brushless DC motor 200.

The identification device 100A is electrically connected to the user system 100 and the brushless DC motor 200 via, for example, a test point (TP). A TP1 is a TP for power supply. A TP2 is a TP for GND. Connecting a dedicated probe to the identification device 100A and bringing the probe into contact with the TP can identify the type of the brushless DC motor 200.

The example embodiments of the present disclosure are widely used in various devices including various fan motors, such as personal computers, game machines, vacuum cleaners, dryers, washing machines, and refrigerators.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-15. (canceled)

16. An identification method used for an identification device that identifies information on a brushless DC motor which is output from the brushless DC motor, the identification method comprising:
supplying a power supply voltage from the identification device to the brushless DC motor via a power line;
rotating the brushless DC motor in accordance with a Pulse Width Modulation (PWM) signal output from a drive circuit of the brushless DC motor upon reception of supply of the power supply voltage;
measuring a reaching time until a driving current flowing through the power line along with rotation of the brushless DC motor reaches a threshold value; and
identifying information on the brushless DC motor based on the reaching time.

17. The identification method according to claim 16, wherein
the information on the brushless DC motor indicates a type of the brushless DC motor; and
the reaching time differs depending on types of a plurality of brushless DC motors.

18. The identification method according to claim 17, wherein a standby time from reception of supply of the power supply voltage to start of output of the PWM signal by the drive circuit of the brushless DC motor is assigned to each type of the plurality of brushless DC motors.

19. The identification method according to claim 18, wherein the drive circuit of the brushless DC motor starts output of the PWM signal after elapse of a predetermined time after reception of supply of the power supply voltage, and further waits for the standby time.

20. The identification method according to claim 17, further comprising in identifying a type of the brushless DC motor:
acquiring unique information of a brushless DC motor based on the reaching time; and
identifying the type of the brushless DC motor from acquired unique information of the brushless DC motor by referring to a table associating a type of the plurality of brushless DC motors with unique information of the plurality of brushless DC motors.

21. The identification method according to claim 16, wherein
information on the brushless DC motor indicates a drive time of the brushless DC motor; and
the reaching time changes according to the drive time of the brushless DC motor.

22. The identification method according to claim 21, wherein a standby time from reception of supply of the power supply voltage to start of output of the PWM signal by the drive circuit of the brushless DC motor changes according to the drive time of the brushless DC motor.

23. The identification method according to claim 16, further comprising notifying a result of identifying information on the brushless DC motor using the identification device.

24. The identification method according to claim 17, further comprising causing a light-emitting element assigned to the brushless DC motor to be identified, among a plurality of light-emitting elements assigned to types of the plurality of brushless DC motors, and to emit light based on a result of identifying a type of the brushless DC motor.

25. The identification method according to claim 16, wherein the brushless DC motor is a fan motor including an impeller.

26. An identification device that identifies information on a brushless DC motor output from a brushless DC motor including a drive circuit that generates a Pulse Width Modulation (PWM) signal and drives the motor, the identification device comprising:
a power supply terminal to supply a power supply voltage to the brushless DC motor via a power line; and
a controller to identify information on the brushless DC motor; wherein
the controller:
measures a reaching time until a driving current flowing through the power line by the brushless DC motor rotating according to the PWM signal output from the drive circuit of the brushless DC motor upon reception of supply of the power supply voltage from the power supply terminal via the power line reaches a threshold value; and
identifies information on the brushless DC motor based on the reaching time.

27. The identification device according to claim 26, wherein
information on the brushless DC motor indicates a type of the brushless DC motor; and
the reaching time differs depending on types of a plurality of brushless DC motors.

28. The identification device according to claim 26, wherein
information on the brushless DC motor indicates a drive time of the brushless DC motor; and
the reaching time changes according to the drive time of the brushless DC motor.

29. A brushless DC motor, comprising:
a circuit board;
a power supply terminal that is on the circuit board to supply a power supply voltage from outside;
a coil; and
a drive circuit to energize the coil; wherein
the drive circuit waits for a standby time assigned to each type of a plurality of brushless DC motors after receiving supply of the power supply voltage, and then starts energizing the coil.

30. A brushless DC motor, comprising:
a circuit board;
a power supply terminal that is on the circuit board to supply a power supply voltage from outside;
a coil; and
a drive circuit to energize the coil; wherein
the drive circuit changes a standby time from reception of supply of the power supply voltage to start of energization of the coil according to a drive time of the brushless DC motor.
